(19) United States
(12) Patent Application Publication
(10) Pub. No.: US 2023/0136641 A1
(43) Pub. Date: May 4, 2023

(54) SYSTEMS AND METHODS FOR OPTIMIZING A VIDEO STORAGE FOOTPRINT WHILE MINIMIZING USER IMPACT

(71) Applicant: Meta Platforms, Inc., Menlo Park, CA (US)

(72) Inventors: Taein Kim, Sunnyvale, CA (US); Carl Taylor, Shoreline, WA (US)

(21) Appl. No.: 17/695,876

(22) Filed: Mar. 16, 2022

Related U.S. Application Data
(60) Provisional application No. 63/275,895, filed on Nov. 4, 2021.

(51) Int. Cl. H04N 19/15; H04N 19/37; H04N 19/127; H04N 19/426

(52) U.S. Cl. CPC H04N 19/15; H04N 19/37; H04N 19/127; H04N 19/426

(57) ABSTRACT

The disclosed computer-implemented method may include generating a table for a plurality of encodings of media files stored in at least one data center, the generating including determining a benefit to cost ratio for each encoding listed in the table based on one or more criteria associated with the respective encoding, and assigning a priority to each of the encodings in the table based on the benefit to cost ratio, determining whether a soft quota for an amount of memory for storage of the media files has been exceeded, and in response to determining that a soft quota for an amount of memory for storage of the media files has been exceeded, performing a data storage reduction process based on the priority associated with each of the encodings in the table. Various other methods, systems, and computer-readable media are also disclosed.

### CROSS REFERENCE TO RELATED APPLICATION

This application claims the benefit of priority under 35 U.S.C. § 119(e) to U.S. Provisional Application No. 63/275,895, filed Nov. 4, 2021, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of an exemplary system for storing and managing media content.

FIG. 2 is an illustration of an exemplary data center for storing and managing media content.

FIG. 3 is an illustration of an exemplary asset management system for managing media content.

FIG. 4 is an illustration of an exemplary table for an asset catalog for use in asset management.

FIG. 5 is an illustration of an exemplary ranked asset table showing encodings for an asset in a decreasing cost benefit ratio order.

FIG. 6 is an illustration of an exemplary ranked asset table showing encodings for an asset in a decreasing cost benefit ratio order (a decreased priority order) where the ranked asset table shows encodings for all assets in a decreasing priority order.

FIG. 7 is a flow diagram of an exemplary method for optimizing a video storage footprint while minimizing user impact.

FIG. 8 is a block diagram of an example system that includes modules for use in implementing a system for storing and managing media content.

FIG. 9 illustrates an exemplary network environment in which aspects of the present disclosure may be implemented.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

A video on demand service may store exabytes of digitally encoded video files. The storing and maintaining of a large number of encoded video files that require exabytes of digital storage may require numerous data centers. The data centers may require a significant amount of energy to operate. In addition, or in the alternative, the video on demand service may incur significant monetary expenses associated with the operation and maintenance of the data centers. Therefore, in order to minimize the monetary and/or energy costs of operating and maintaining the data centers, a video on demand service may choose to store a select number of digitally encoded video files. The video on demand service may find it challenging when determining which digitally encoded video files to keep in storage and which digitally encoded video files to delete from storage in order to reduce or minimize the amount of storage needed for the digitally encoded video files without negatively impacting a user experience with the video on demand service.

In some implementations, a video on demand service may generate and/or store one or more digital encodings for an original video file. For example, a video on demand service may generate and/or store one or more digital encodings derived from an original video file that may include, without limitation, encodings of the original video file encoded at various resolutions (e.g., visual qualities). Each derived encoding may be considered a derivative of the original video file. As such, each derived encoding is based on the original video file.

In another example, a video on demand service may generate and/or store more than one digital encoding for an original video file (e.g., two or more digital encodings of the original video file). Replicating the digital encodings of the original video file may allow the video on demand service to store multiple copies of the digital encoding of the original video file in different data centers. The video on demand service may assign a replication factor to an original video file that indicates how many copies of the original video file are stored in memory in data centers for instant accessibility by the video on demand service. In some implementations, a frequency of the delivery of encoding families for the original video may determine how many copies of the original video file may be stored in the data centers. The larger the number of instantly accessible copies of the original video file stored in the data centers the greater the accessibility of the original video file, the lower a probability that a user may not be able to gain access to the original video file, and/or the lower the probability of comprised availability of the original video file.

In some implementations, an original video file may be deleted or removed from storage. In these implementations, one or more source encodings of the original video file may be maintained or kept in storage. For example, the maintained source encodings may be encodings of the original video file that have lower storage costs and that the video on demand service may use to create or generate one or more derived encoding files of the original video file. Maintaining at least one source encoding can ensure that the video on demand service does not incur any data loss because the source encoding may be considered a copy of a visual representation of the original video file. In some cases, the source encoding may have a lower visual quality as compared to the original video file.

A video on demand service may determine the selection of which video files to keep in storage and which video files to delete from storage based on the impact the deleting of the video file would have on a user experience. For example, deleting an original digitally encoded video file to save storage space may be considered a data loss incident that may have the potential to negatively impact the user experience because the video file is no longer available to the user for viewing.

In some implementations, the video on demand service may delete one or more derived encodings for the original video file. Deleting a derived encoding of an original video file to save storage space may negatively impact a user experience. For example, a user experience may be diminished if the user, when choosing to view the video file, is presented with the selection of a derived encoding of the video file that is at a resolution less than a resolution capable of being delivered to a computing device of the user. The selection of such a reduced resolution derived encoding may result in the user viewing a particular derived digital encoding of the video file on a computing device of the user that is capable of playing digital encodings at a higher, greater, or better visual quality that is offered by the particular derived digital encoding.

In another example, the user experience may be diminished if the user, when choosing to view the video file, is presented with the selection of the digital encoding of the original video file. Such a selection may result in the downloading of more data (e.g., bytes) to the computing device of the user than is needed to play the video file on the computing device at a resolution that provides a satisfactory visual quality of the video file to the user. For example, the computing device of the user may need to buffer all or at least a portion of the digital encoding of the original video file as it is downloaded and viewed by the user on the computing device at a satisfactory visual quality. The buffering may not only use up network bandwidth but may cause pauses and/or breaks in the playing of the video file negatively impacting the user experience. For example, if the user subscribes to a data plan for a network that is of a limited amount, downloading the digital encoding of the original video file may use a significant amount of the allotted data for the data plan.

in another example, the computing device of the user may generate a derived encoding of the downloaded original video file for playing by the computing device at a resolution that provides a satisfactory visual quality of the video file to the user. The generating of the derived encoding of the downloaded original video file may incur the computing resources and expenses of the downloading of the data for the digital encoding of the original video file along with the computational resources of the generating of the derived encoding by the computing device of the user. The use of a significant number of computational resources by the computing device of the user may negatively impact the user experience when viewing the video file by introducing delays in the playing of the video file.

A video on demand service may implement a capped or fixed data storage budget (e.g., a soft quota) for video file storage to keep data storage costs under control. In some implementations, a data storage budget may selectively delete digital encodings of video files based on certain criteria to reduce any negative impact the deletion may have on a user experience. Providing the selective deleting may result in achieving an improved and better user experience as compared to an experience of a user when randomly deleting digital encodings of video files (e.g., deleting the digital encodings of the video files using little if any criteria for the selection and deletion of the video files).

A video on demand service may implement systems and methods that detect when total data storage for digitally encoded video files meets or exceeds a soft quota. When detected, the video on demand service may implement one or more data storage reduction processes (e.g., clean up processes) aimed at reducing a storage footprint for the digitally encoded video files while reducing any negative impact such a reduction would have on an experience of a user of the video on demand service.

In some implementations, a video on demand service may generate or build an asset management table that includes information and data related to each encoding family (e.g., set of similar digital encodings for a video file) stored in memory in one or more data centers. For example, the asset management table may include at least one row for each encoding family (e.g., set of similar digital encodings for a video file) and one or more columns. A first column may include an entry related to a visual quality benefit for the encoding family (e.g., a BD-rate). A second column may include an entry related to a frequency of future deliveries of the encoding family to users. For example, a machine learning model may use historical data for how often an encoding family is delivered to users to predict a frequency of potential future deliveries of the encoding family to users. A third column may include an entry related to a compute cost to regenerate the encoding family (e.g., a compute cost related to the regenerating of the encoding if it were deleted and no longer available yet requested for viewing by a user). A fourth column may include an entry related to a storage cost (e.g., an amount of storage memory and/or operating cost associated with the amount of memory) for maintaining and/or keeping the encoding family in storage in memory a data center.

The columns included in the asset management table may be for criteria for use by a data storage reduction process when selectively determining whether to delete certain digital encodings of video files in an effort to reduce a storage footprint for the video on demand service. The video on demand service may use the criteria provided by the entries in the columns of the asset management table for an encoding family to determine what, if any, negative impact on an experience of a user the deletion of the encoding family from storage in a memory of a data center would have.

The present disclosure is generally directed to systems and methods for storing and managing media content that may include storing, managing, cataloging, prioritizing, and delivering of encodings of an original media file to a playback computing device. In some implementations, the media content may include one or more of original video files, sanitized original files, and derived encodings of original video files. In some implementations, the media content may be in various states of replication across different storage solutions. The different storage solutions may include, but are not limited to, long term low accessibility backup storage solutions, highly available single file storage solutions, and low single file but able to fallback to another file within a family storage solutions. An asset management system for a media content provider may manage the layout and storage of the files for the media content along with replication states for the files across the plurality of storage solutions. In some cases, the plurality of storage solutions may have disparate costs and capabilities.

As will be explained in greater detail below, embodiments of the present disclosure may generate a table that includes entries for a plurality of original or source media files and a plurality of encodings of media files stored in at least one data center. The generating may include dynamically determining a storage benefit to cost ratio for each encoding listed in the table based on one or more criteria associated with the respective encoding and assigning a priority to each of the encodings in the table based on the benefit to cost ratio. The systems and methods may further include determining whether a soft quota for an amount of memory for storage of the media files has been exceeded, and in response to determining that a soft quota for an amount of memory for storage of the media files has been exceeded, performing a data storage reduction process based on the priority associated with each of the encodings in the table.

In some implementations, a data storage reduction process using the information and data included in an asset management table may apply or assign a higher priority to digital encodings of video files that are often watched and that have high visual quality benefit with a small or low storage cost and may apply or assign a lower priority to digital encodings of video files that are not frequently watched or not watched at all and that have a large or high storage cost. For example, digital encodings of video files that are often watched may be encoding families where digital encodings of the video files are delivered to users at or above a particular frequency. For example, digital encodings of video files that have a high visual quality benefit may be digital encodings of video files that have a Bjontegaard function or metric (BD-Rate) above a particular threshold level. For example, digital encodings of video files that have a small or low storage cost may be digital encodings of video files that utilize an amount of storage memory below or less than a particular threshold amount. For example, digital encodings of video files that are not frequently watched or not watched at all may be encoding families where digital encodings of the video files are delivered to users below a particular frequency or not at all. For example, digital encodings of video files that have a large or high storage cost may be digital encodings of video files that utilize an amount of storage memory above a particular threshold amount.

In some implementations, a data storage reduction process may begin a reduction process by processing the digital encodings of the video files based on their priority until a particular storage goal is achieved. For example, if the data storage reduction process determines that a soft quota for an amount of memory for data storage is met or exceeded, the data storage reduction process may begin deleting digitally encodings of video files based on their priority ranking, beginning with the files having the lowest priority (e.g., the least valuable files) until the amount of memory for data storage is below the soft quota.

In some implementations, a data storage reduction process may not delete an original video file allowing users the ability to view the original video file in the future even if a current user watch frequency indicates that users may not be frequently watching the original video file (e.g., watching the original video file at a frequency below a particular dynamic threshold level based on current usage conditions for the media content stored in the data centers) or that users may not be watching the original video file at all (e.g., not watching the original video file within a particular timeframe (e.g., within a week, within a month, within a year)).

In some implementations, though the data storage reduction process may not delete the original video file, the data storage reduction process, based on the user watch frequency, may reduce a replication factor for the storage of the original video file in order to reduce memory consumption in the data centers. For example, a data storage reduction process may use a priority value assigned to an encoding file and an amount of memory that exceeds a soft quota for an amount of memory for data storage to determine a least number of encodings to remove or delete from storage in the data centers. For example, in cases where the soft quota for an amount of memory for data storage for media content is not met or exceeded, even infrequently watched video files, and associated encoding files may be kept or maintained in storage in the data centers. For example, in cases where the soft quota for an amount of memory for data storage for media content is exceeded, even frequently watched video files and associated encoding files may be removed or deleted from storage in the data centers based on the need to free up available storage in the data centers.

In some implementations, a data storage reduction process may reduce a replication factor for digital encodings derived from the original video file based on a user watch frequency for the derived encoding of the video file. For example, a user watch frequency may indicate that users may not be frequently watching the derived encoding of the video file (e.g., watching the derived encoding of the video file at a frequency below a particular dynamic threshold level) or that users may not be watching the derived encoding of the video file at all (e.g., not watching the derived encoding of the video file within a particular timeframe (e.g., within a week, within a month, within a year)). In some implementations, though the data storage reduction process may not delete the derived encoding of the video file, the data storage reduction process, based on the user watch frequency, may reduce a replication factor for the storage of the derived encoding of the video file in order to reduce memory consumption in the data centers.

In some implementations, a data storage reduction process may delete particular digital encodings derived from the original video file based on a user watch frequency for the particular derived encoding of the video file. For example, a user watch frequency may indicate that users may not be frequently watching the particular derived encoding of the video file (e.g., watching the particular derived encoding of the video file at a frequency below a particular dynamic threshold level) or that users may not be watching the particular derived encoding of the video file at all (e.g., not watching the derived encoding of the video file within a particular timeframe (e.g., within a week, within a month, within a year)). In some implementations, the data storage reduction process may delete the derived encoding of the video file based on the user watch frequency in order to reduce memory consumption in the data centers. In the future, if demand so dictates, the video on demand service may regenerate the particular derived encoding of the video file from the original video file that is still stored in the data centers for the video on demand service.

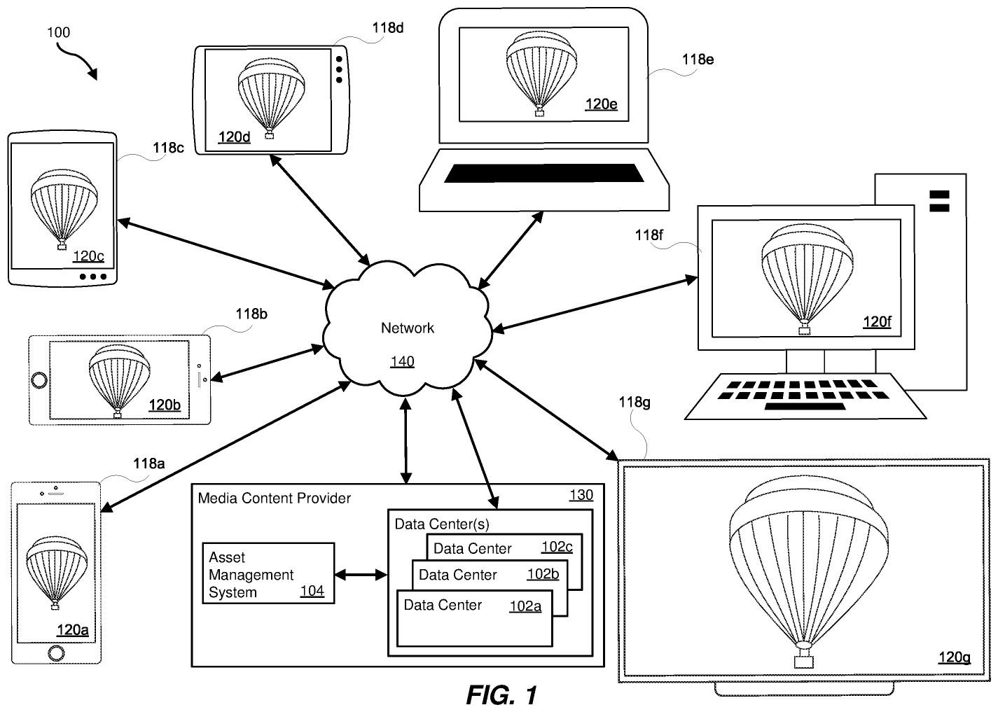

The following will provide, with reference to FIGS. 1-4, detailed descriptions of the storing, managing, cataloging, prioritizing, and delivering of encodings of an original media file to a playback computing device.

FIG. 1 is an illustration of an exemplary system 100 for storing, managing, and delivering media content. The system 100 may include a media content provider 130. The media content provider 130 may include one or more data centers 102a-c and an asset management system 104. The asset management system 104 may manage the storage and delivery of media content included in the data centers 102a-c. For example, media content may be stored as one or more assets in the data centers. Media content may include, without limitation, original video files, encoded video files, derived encoded video files, and replicated video files. In some implementations, the media content provider 130 may be a video on demand service that may store exabytes of digitally encoded video files in the data centers 102a-c for management and delivery by the asset management system 104.

Data centers may store a large number of encoded video files that require exabytes of digital storage. Though the example shown in FIG. 1 includes three data centers 102a-c, in some implementations, the media content provider 130 may provide and/or include less than three data centers (e.g., one data center, two data centers). In some implementations the media content provider 130 may provide and/or include more than three data centers (e.g., four data centers, ten data centers, one hundred data centers, one thousand data centers, etc.). Descriptions in this document for the data center 102a may be applied to any and all data centers provided by and/or included in a media content provider.

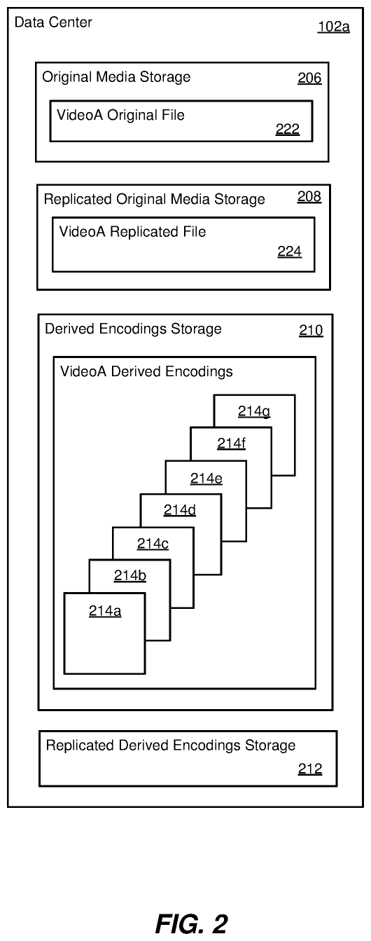

FIG. 2 is an illustration of an exemplary data center (e.g., the data center 102a) that may be included in a media content provider (e.g., the media content provider 130). A data center may include at least one of original media storage, replicated original media storage, derived encodings storage, or replicated derived media storage. For example, the data center 102a may include original media storage 206 and replicated original media storage 208. The replicated original media storage 208 may include one or more replicated versions or copies of each asset included in the original media storage. The data center 102a may include derived encodings storage 210 and replicated derived encodings storage 212. The replicated derived encodings storage 212 may include one or more replicated versions or copies of each derived encoding included in the derived encodings storage 210.

In some implementations, the storage included in the data centers may be one or more repositories or databases included in memory. The memory may include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

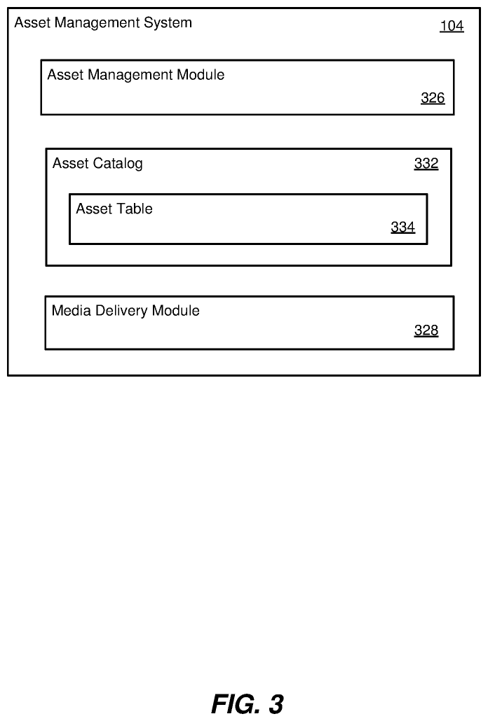

FIG. 3 is an illustration of an exemplary asset management system (e.g., the asset management system 104) that may be included in a media content provider (e.g., the media content provider 130). Referring to FIG. 2, an original video file may be stored in original media storage. For example, an original video file (e.g., videoA original file 222) may be stored in the original media storage 206. In some implementations, an asset management system may generate one or more replicated versions of an original video file that may be stored in replicated original media storage. For example, an asset management module 326 included in the asset management system 104 may generate a replication or copy of the videoA original file 222. The replication of the original video file (e.g., videoA replicated file 224) may be stored in the replicated original media storage 208. Though FIG. 2 shows a single replication (videoA replicated file 224) of the videoA original file 222, in some implementations, more than one (two or more) replications of the videoA original file 222 may be stored in the replicated original media storage 208.

An asset management system may interface with one or more datacenters to observe delivery frequency of media content to a playback device. In some implementations, an asset management system (e.g., the asset management system 104) may interface directly with each of the one or more datacenters (e.g., data centers 102a-c). In some implementations, an asset management system (e.g., the asset management system 104) may interface with each of the one or more data centers (e.g., the data centers 102a-c) by way of a network (e.g., the network 140). The asset management system may use an observed delivery frequency of media content from a data center to a playback device (e.g., a number of times the specific media content is delivered to a playback device) to predict future delivery frequencies for the specific media content. For example, the asset management system 104 may use the observed delivery frequency for the media content when optimizing a video storage footprint for the media content provider 130 that minimizes impact of a user experience while interacting with (e.g., viewing, listening to) the media content.

In some implementations, a media delivery module may provide a best encoding to a playback computing device to maximize a video quality for the display of the encoding on the display device of the playback computing device. For example, referring to FIGS. 1 and 3, a media delivery module 328 may provide a best encoding for display on a display device 120g of a playback computing device 118g that may be a four kilobyte resolution video encoding. In another example, the media delivery module 328 providing a four kilobyte resolution video encoding to the playback computing device 118a for display on the display device 120a may not be beneficial if the display device 120a is not capable of displaying a four kilobyte resolution video encoding. For example, in cases where the network 140 may provide a slow or unreliable connection between the media content provider 130 and a playback computing device, the media delivery module 328 providing a high resolution, large video encoding to the playback computing device may result in video pauses while the user is watching the video due to network buffering. In another example, the media delivery module 328 providing a high resolution, large video encoding to the playback computing device may result in increased network costs to the user because of the large amount of real-time streaming video data.

A media delivery module included in an asset management system may provide a best encoding to a playback computing device to maximize a video quality for the display of the encoding on the display device of the playback computing device while minimizing a negative user experience. For example, the media delivery module 328 may provide a best encoding to the playback computing devices 118a-g to maximize a video quality for the display of the encoding on the respective display devices 120a-g of the playback computing devices 118a-g while minimizing a negative user experience. For example, a media delivery module 328 included in the asset management system 104 may interface with playback computing devices 118a-g by way of the network 140. A playback computing device may request playing of a video file from the media content provider 130. For example, the playback computing device 118a may communicate with the asset management system 104 of the media content provider 130 by way of the network 140. The playback computing device 118a may request playback of videoA for display on the display device 120a. The asset management system 104 may interface with the data centers 102a-c to observe a delivery frequency of a derived encoding of an original video file (e.g., videoA derived encodings 214a-g) to a target playback computing device (e.g., playback computing devices 118a-g, respectively) for display on a display device of the playback computing device (e.g., display devices 120a-g, respectively).

A media content provider may generate one or more derived encodings for an original video file where each derived encoding is optimized for playback and viewing on a display device of a specific playback computing device. Such optimizations may provide a best user experience when viewing the video on a playback device of the user. For example, the videoA derived encodings 214a-g may each be derived to provide an optimal viewing experience on the respective display devices 120a-g of each respective playback computing device 118a-g providing a positive user experience to users of each of the playback computing devices 118a-g. For example, in response to receiving a request for playback of videoA from the playback computing device 118a, the media delivery module 328 may interface with the data center 102a to provide the videoA derived encoding 214a to the playback computing device 118a by way of the network 140. The playback computing device 118a may render or play the videoA derived encoding 214a on the display device 120a.

In some implementations, the playback computing device 118a and the playback computing device 118b may be the same computing device or the same type of computing device. The playback computing device 118a may be in a vertical or portrait orientation and the playback computing device 118b may be in a horizontal or landscape orientation. In some implementations, the playback computing device 118c and the playback computing device 118d may be the same computing device or the same type of computing device. The playback computing device 118c may be in a vertical or portrait orientation and the playback computing device 118d may be in a horizontal or landscape orientation.

A media content provider may provide an encoded version of the original media content that is derived from the original media content. The media content provider may provide an encoded version to a playback display device included in a playback computing device. The derived encoding may be an encoding of an original video file that is derived based on one or more criteria associated with a target playback computing device for the derived encoding. The one or more criteria may include, without limitation, one or more of a resolution of a display device of the playback computing device, and a network access ability and speed of the playback computing device when interfacing with a network that will provide (e.g., stream) the derived encoding of the video file to the playback computing device.

Data centers may store a large number of encoded video files that require exabytes of digital storage. As such, a video on demand service may include numerous data centers that consume a significant amount of energy to operate contributing to the costs of running the video on demand service. In addition, or in the alternative, the video on demand service may incur significant monetary expenses associated with the operation and maintenance of the data centers. To minimize the monetary and energy costs of the operating and maintaining of data centers, a media content provider may implement a soft quota for an amount of digital storage the media content provider may make available for the storage of encoded video files.

A media content provider may implement an asset catalog for use in managing the storage of encoded video files. The media content provider may use information and data associated with each asset included in the asset catalog for managing the storage of each asset in memory included in one or more data centers. A media content provider may have a soft quota for an allowable amount of memory for storage of media content as assets in one or more data centers. The media content provider may maintain storage of the media content within the soft quota amount by using the information and data associated with each asset in the asset catalog to generate a prioritized list or table of the assets. An asset management system of the media content provider may use the prioritized asset list or table to determine which assets may be deleted from the memory in order to meet and/or be within the soft quota amount of memory.

Using the prioritized list or table of media assets to determine which digitally encoded data files to keep in storage and which digitally encoded data files to delete from storage may keep or maintain the amount of storage needed for the digitally encoded video files within the soft quota amount without negatively impacting a user experience for the playback of a video file on a display device of a playback computing device. For example, referring to FIG. 3, the media content provider 130 may include an asset catalog 332. The asset catalog 332 may include information and data associated with each videoA derived encoding 214a-g in an asset table 334. The information and data may be related to criteria for each derived video encoding. In addition, or in the alternative, a media content provider may use information and data associated with each derived encoding for an original video file to determine a replication factor (e.g., how many copies of a derived encoding should be stored in replicated derived encodings storage) for each derived encoding.

A media content provider may use a benefit-cost model to determine the most cost-effective way to manage a storage footprint for video encoding storage without negatively impacting the experience of a user while viewing the video. The benefit-cost model may model the cost of the computing expense of regenerating a derived encoding for an original video file verses the cost of storing the derived encoding in memory in a data center.

For example, a benefit-cost model may be defined, in general, as shown in Equation 1 and Equation 2.

Benefit=(relative compression efficiency of an encoding family at a fixed quality)*(effective predicted watch time) Equation (1)

Cost=normalized compute cost of the missing encodings in the family of encodings Equation (2)

where an encoding family includes derived encodings for an original video file.
The Benefit (Equation 1) may capture an amount of compression efficiency a media content provider may improve for every second of watch time of an encoding family by a user. For example, a second of watch time may be represented as a unit (e.g., one unit) of a user experience. In some implementations, the Benefit (Equation 1) may also capture derivative metrics which may include, but are not limited to, a measure of the perceived quality of a derived encoding, a relative measure of the performance of a derived encoding, and an amount of time needed to generate the derived encoding. The Cost (Equation 2) may be an amount of logical computing cycles needed to generate a minimum number of derived encodings of an original video file for delivery to users.

A media content provider may use an updated benefit-cost model to improve compression efficiencies for derived encodings of original video files. In some implementations, in addition or in the alternative, a media content provider may update, revise, or otherwise modify a benefit-cost model to generate a compute and storage efficient benefit-cost model to improve storage reduction actions. An asset management system of a media content provider may use the compute and storage efficient benefit-cost model to determine (calculate) a compute and storage benefit-cost for each individual derived encoding for all derived encodings. For example, the asset management system of the media content provider may use the compute and storage efficient benefit-cost model to implement storage reduction actions at a derived encoding level instead of at an original video file level. Therefore, instead of reducing storage for all derived encodings associated with a lowest value ranked original video files, storage may be reduced for lowest value ranked derived encodings regardless of the ranking of the original video file they are associated with because each individual derived encoding will have associated benefit-cost characteristics as determined by the compute and storage efficient benefit-cost model. In some implementations, in addition or in the alternative, a media content provider may also want to use a compute and storage efficient benefit-cost model to capture any negative user experience, and/or any resource consumption that is being prevented by keeping the derived encoding file in storage in memory in one or more of the data centers.

In some implementations, a compute and storage efficient benefit-cost model may be defined as shown in Equation 3 and Equation 4 to include modeling for improved compression efficiencies as well as modeling for improved storage reduction actions.

Benefit=MVHQ*(effective video watch time)*(additional benefits) Equation (3)

Cost=number of physical bytes of memory in one or more data centers used for the storage of the derived encoding files for an original video file Equation (4)

where Minutes of Video at High Quality per Gigabyte (GB) datapack (MVHQ) determines, given an internet allowance, how many minutes of high-quality video data can be streamed to a playback device of a user as shown in Equation 5.

$$MVHQ = \frac{1 GB}{\begin{matrix}Average ( MvhqBitratevid 1 , \\ MvhqBitratevid 2 , … MvhqBitratevid n )\end{matrix}} \qquad Equation ( 5 )$$

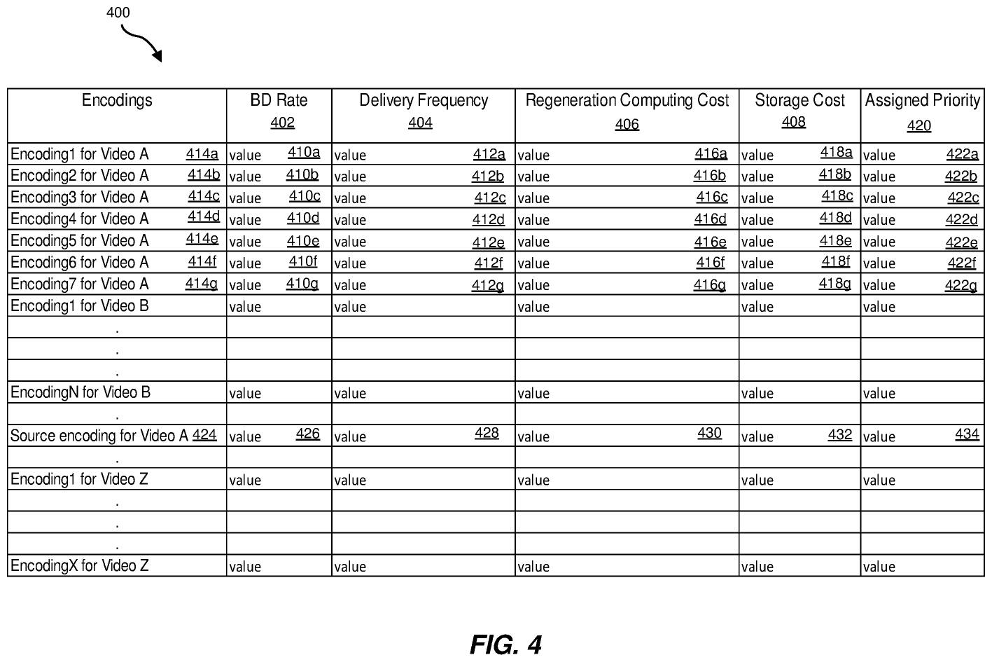

The effective video watch time may be an expected watch time for each of the derived encodings. For example, a past watch time for a derived encoding may be used to predict a future watch time for the derived encoding. The effective watch time may be a delivery frequency of the derived encoding. The additional benefits may include, but are not limited to, computing resource savings by keeping a derived encoding (not deleting the derived encoding from storage memory) and not having to re-generate the recording which would require the use of computing resources, and a visual quality benefit for the derived encoding, which will be described in more detail with reference to FIG. 4.

As will be described in more detail in FIGS. 4-6, an asset table may include a row for each derived encoding for each original media content file. The asset table may include values for criteria associated with the derived encodings. A first criterion may be a visual quality benefit for the derived encoding. A second criterion may be a delivery frequency of the derived encoding. A third criterion may be a regeneration computing cost for the derived encoding. A fourth criterion may be a storage cost for the derived encoding. The asset table may include a priority assigned to each derived encoding.

FIG. 4 is an illustration of an exemplary asset table 400 for storage in an asset catalog for use in asset management. For example, referring to FIG. 3, the asset table 400 may be the asset table 334 included in or stored in the asset catalog 332 included in the asset management system 104. The asset management module 326 may use the information and data stored in the asset table 334 for the management of the storage and delivery of media content stored as assets in the one or more data centers 102a-c.

An asset table may include a row for each asset stored in a data center. The stored assets may include, without limitation, the derived encodings for each original media content file stored in the data center and/or one or more source or original encodings. For example, the asset table 334 may include a row for each original or source encoding. Referring to FIG. 1, the asset table 334 may include a row for each videoA derived encoding 214a-g (e.g., videoA derived encoding entries 414a-g, respectively). The asset table 334 may include values for criteria associated with the derived encodings. In addition, or in the alternative, the asset table may include a row for each original or source encoding (e.g., source encoding for videoA entry 424 for VideoA original file 222). The asset table 334 may include values for criteria associated with each original or source encoding. A first criterion may be a visual quality benefit determined by the use of Bjontegaard functions (BD rate 402). A second criterion may be a delivery frequency 404. A third criterion may be a regeneration computing cost 406. A fourth criterion may be a storage cost 408. The asset table 334 may include a priority 420 assigned to each derived encoding.

An asset management module may determine a visual quality benefit (a BD rate) for a derived encoding using a Bjontegaard Metric. An asset management module may determine a visual quality benefit (a BD rate) for an original or source encoding using a Bjontegaard Metric. For example, referring to FIG. 1, the asset management module 326 may determine the BD rate 402 for the videoA derived encoding 214a. A BD rate may be a value representative of a data rate savings incurred by the delivery of the derived encoding by high efficiency video coding (HEVC) as compared to advanced video coding (H.264), and a quality improvement for the derived encoding as compared to a quality of the derived encoding when delivered at an equivalent data rate ((e.g., measured as peak signal-to-noise ratios (PSNR)). The BD rate 402 for the videoA derived encoding 214a may be BD rate value 410a. For example, the BD rate value 410a may be a percentage representative of a percent reduction in the data rate delivery of the videoA derived encoding 214a to the playback computing device 118a when delivered using HEVC as compared to H.264 while maintaining (not degrading) a quality of the derived encoding. For example, while maintaining the quality of the derived encoding, the higher (larger or greater percentage value) a BD rate the greater the percentage reduction in the data delivery rate providing a data delivery rate savings. The asset management module 326 may determine BD rate values 410a-g for each videoA derived encoding entry 414a-g, respectively, in the asset table 334. The asset management module 326 may determine a BD rate value 426 for the source encoding for videoA entry 424 in the asset table 334.

An asset management module may determine a delivery frequency for a derived encoding. An asset management module may determine a delivery frequency for an original or source encoding. For example, referring to FIG. 3, the asset management module 326 may determine a delivery frequency 404 for the videoA derived encoding 214a. A delivery frequency may be a value representative of a predicted future delivery frequency based on how often a derived encoding was delivered to a playback computing device. The delivery frequency 404 for the videoA derived encoding 214a may be BD rate value 410a. For example, the delivery frequency value 412a may be a numerical value representative of a number of deliveries of the videoA derived encoding 214a to a playback computing device. In some implementations, the delivery frequency value 412a may be over a time period that may include, but is not limited to, the last day, the last week, the last month, the last year, or over the life of the videoA derived encoding 214a. The larger the delivery frequency the greater the number of times that a derived encoding is delivered to a playback computing device. The asset management module 326 may determine delivery frequency values 412a-g for each videoA derived encoding entry 414a-g, respectively, in the asset table 334. The asset management module 326 may determine a delivery frequency value 428 for the source encoding for videoA entry 424 in the asset table 334.

An asset management module may determine a regeneration computing cost for a derived encoding. An asset management module may determine a regeneration computing cost for an original or source encoding. For example, referring to FIG. 3, the asset management module 326 may determine a regeneration computing cost 406 for the videoA derived encoding 214a. A regeneration computing cost may be a computing cost to regenerate a derived encoding of an original video file. For example, if an asset management system identifies a specific derived encoding for an original video file for deletion, the regeneration computing cost may be a value representative of a computing cost associated with the regeneration of the specific derived encoding if requested for delivery to a playback computing device. The regeneration computing cost 406 for the videoA derived encoding 214a may be regeneration computing cost value 416a. For example, the regeneration computing cost value 416a may be a numerical value representative of a computational cycles (e.g., central processing unit (CPU) processing cycles) along with energy costs associated with the increased CPU usage. In some implementations, the regeneration computing cost value 416a may be over a time period that may include, but is not limited to, the last day, the last week, the last month, the last year, or over the life of the videoA derived encoding 214a. The larger the regeneration computing cost the less likely that the asset management module 326 may mark a derived encoding for deletion from data center storage. The asset management module 326 may determine regeneration computing cost values 416a-g for each videoA derived encoding entry 414a-g, respectively, in the asset table 334. The asset management module 326 may determine a regeneration computing cost value 430 for the source encoding for videoA entry 424 in the asset table 334.

An asset management module may determine a storage cost for a derived encoding. An asset management module may determine a storage cost for an original or source encoding. For example, referring to FIG. 3, the asset management module 326 may determine a storage cost 408 for the videoA derived encoding 214a. A storage cost may be a cost to store a derived encoding of an original video file. For example, the storage cost may be a value representative of a cost associated with criteria for one or more data centers that may include, without limitation, a number of data centers, an amount of storage memory provided by the data centers, energy costs associated with running the data centers, and/or a maintenance cost associated with the upkeep of the data centers. The storage cost 408 for the videoA derived encoding 214a may be storage cost value 418a. For example, the storage cost value 418a may be a numerical value representative of one or more or a combination of criteria associated with the one or more data center 102a. In some implementations, the storage cost value 418a may be over a time period that may include, but is not limited to, the last day, the last week, the last month, the last year, or over the life of the videoA derived encoding 214a. The larger the storage cost the more likely that the asset management module 326 may mark a derived encoding for deletion from data center storage. The asset management module 326 may determine storage cost values 418a-g for each videoA derived encoding entry 414a-g, respectively, in the asset table 334. The asset management module 326 may determine a storage cost value 432 for the source encoding for videoA entry 424 in the asset table 334.

A benefit to cost ratio for an asset may indicate if a benefit of keeping an asset (not deleting an asset from memory) outweighs the cost of maintaining the asset in storage. Stated in another way, a benefit to cost ratio for an asset may be used to determine if a storage state for a particular encoding is appropriate or if benefits provided by a current storage state for the particular encoding are largely unrealized and possibly downgraded based on any memory management storage pressure on the overall storage systems. For example, referring to FIG. 3, the asset management module 326 may assign a priority value 422a-g to each videoA derived encoding entry 414a-g, respectively, in the asset table 334 based on a benefit to cost ratio for the respective videoA derived encoding entry. In addition, or in the alternative, the asset management module 326 may assign a priority value 434 to the source encoding for videoA entry 424 in the asset table 334 based on a benefit to cost ratio for the source encoding for videoA entry 424.

An asset management system may assign a first priority to a first asset that is higher or greater than a priority assigned to a second asset if a benefit to cost ratio of the first asset is larger or greater than a benefit to cost ratio of the second asset. The higher priority asset may be considered more valuable than the lower priority asset. Stated in another way, the lower priority asset may be considered less valuable than the higher priority asset. Referring to FIGS. 1-3, for example, a benefit to cost ratio for the videoA derived encoding 214b may be a higher benefit to cost ratio than the benefit to cost ratio for the videoA derived encoding 214g. Therefore, the asset management system 104 may assign or associate a priority to the videoA derived encoding entry 414b in the asset table 334 that is higher than a priority assigned to or associated with the videoA derived encoding 214g. The asset management system 104 may then rank the videoA derived encoding entry 414b higher than the videoA derived encoding entry 414g indicating that the videoA derived encoding entry 414b may be considered more valuable than the videoA derived encoding entry 414g.

In general, a particular derived encoding file and/or a particular source encoding file may be assigned or associated with a higher priority as compared to other derived encoding files and/or other source encoding files in a ranked asset table if the particular derived encoding or source encoding is watched more frequently than the other derived encodings or other source encodings. In some implementations, another contributing factor to the ranking or priority of a particular derived encoding file in the ranked asset table may be a visual quality benefit of the derived encoding as compared to a storage cost for storing the particular derived encoding file. Another contributing factor to the ranking or priority of the derived encoding file in the ranked asset table may be a visual quality benefit of the derived encoding as compared to a regeneration computing cost for regenerating the particular derived encoding file.

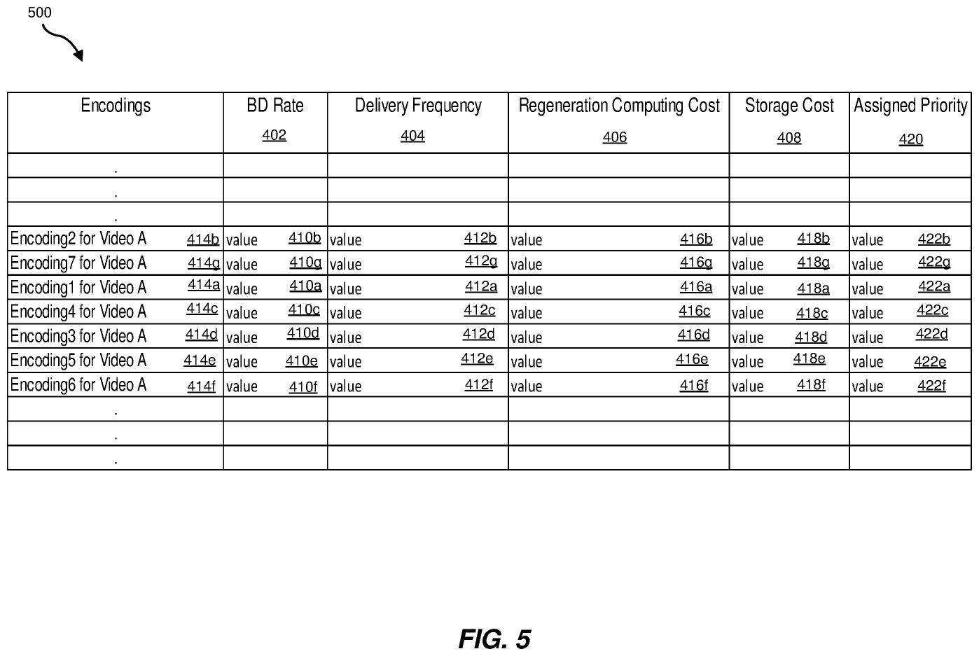

FIG. 5 is an illustration of an exemplary ranked asset table 500 showing derived encodings for an asset in a decreasing cost benefit ratio order (a decreased priority order). Referring to FIGS. 1 and 2, the ranked asset table 500 may be included in the asset catalog 332. The exemplary ranked asset table 500 shows derived encodings of videoA in a ranked order. The ranked asset table may include derived encodings for additional original media content where each group or family of derived encodings are ranked relative to one another, and each family of derived encodings is ranked relative to other families of derived encodings. In some implementations, each derived encoding family or group (e.g., derived encodings for a specific video file) may be ranked in relation to each derived encoding family or group member as shown in FIG. 4. In some implementations, derived encoding files and source encoding files may be ranked relative to one another. In some implementations, each group or family of derived encodings may be ranked relative to one another, and each family of derived encodings may be ranked relative to other families of derived encodings and relative to source encoding files.

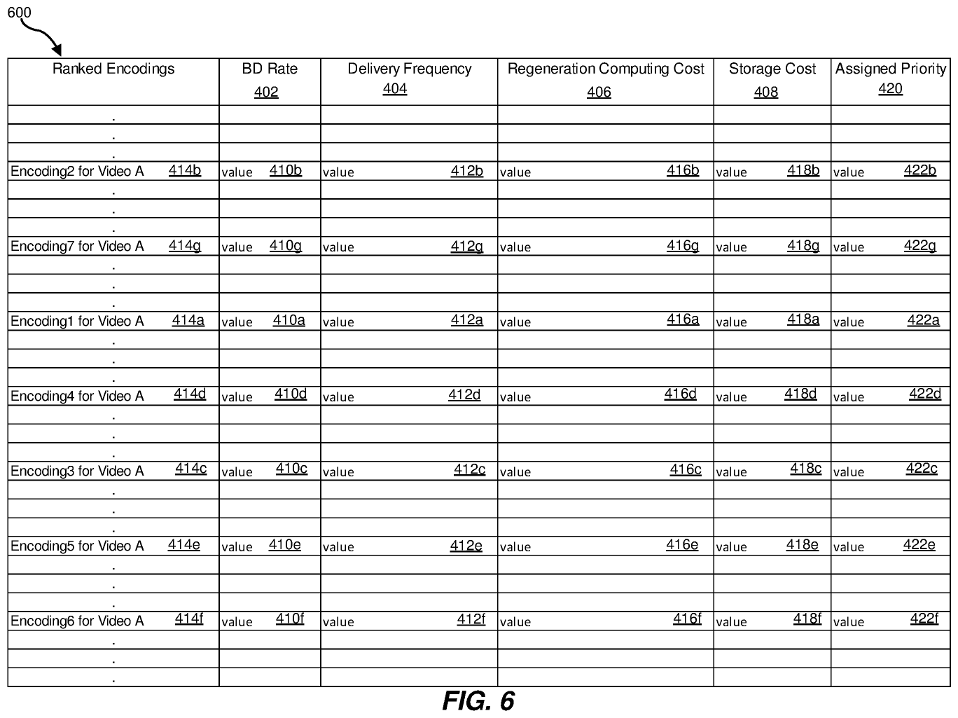

FIG. 6 is an illustration of an exemplary ranked asset table 600 showing derived encodings for an asset in a decreasing cost benefit ratio order (a decreased priority order) where the ranked asset table 400 shows derived encodings for all assets in a decreasing priority order. In some implementations, a ranked asset table may include derived encodings for all assets (source encoding and derived encodings) in a decreasing priority order. Referring to FIGS. 1 and 3, the ranked asset table 600 may be included in the asset catalog 332. The exemplary ranked asset table 600 shows derived encodings of videoA in a ranked order as compared to all derived encodings for all original media files. In some implementations, a ranked asset table may further rank all source encodings along with all derived encodings for original media files. Each derived encoding of a plurality of derived encodings for many original video files may be ranked in relation to one another as shown in the ranked asset table 400. In addition, in some implementations, an asset management system may determine, generate, or calculate a cost benefit ratio value for each original video file. In these implementations, the original video files may be ranked in order along with the derived encoding files.

An asset management module may update an asset catalog and/or an asset table on a periodic or regular basis. For example, referring to FIG. 3, the asset management module 326 may update the asset table 334 on a time frame basis such as every hour, every day, every week, or every month. In addition, or in the alternative, when updating an asset table, an asset management system may update values for the criteria associated with an asset and then may assign an updated priority to an asset entry in the asset table based on the updated values for the criteria. For example, an update to an asset table may result in an asset entry being assign a priority that is different from a prior assigned priority. In addition, or in the alternative, the asset management module 326 may update the asset catalog based on an event occurring with the media content provider 130. For example, the event may be the storage of a particular number (e.g., ten, one hundred, one thousand) of new original video files, and/or the generation of a particular number of derived encodings (e.g., one thousand, one hundred thousand, one million).

An asset management system may monitor an amount of data storage for digitally encoded video files. A media content provider may set a capped or fixed data storage budget (e.g., a soft quota) for file storage in one or more data centers to keep data storage costs under control. In some implementations, the asset management system 104 may selectively delete digital encodings of video files in the one or more data center 102a when total data storage for the digitally encoded video files meets or exceeds the soft quota. The asset management system 104 may implement one or more data storage reduction processes (e.g., clean up processes) aimed at reducing a storage footprint for the digitally encoded video files while avoiding any negative impact such a reduction would have on an experience of a user viewing a video file on a playback device.

For example, a derived encoding file (e.g., videoA derived encoding entry 414b) may be ranked at a higher priority than other derived encoding files (e.g., videoA derived encoding entry 414a, videoA derived encoding entries 414c-g) in storage in one or more data centers if the derived encoding file is watched more often (is frequently watched, is watched more than a dynamic threshold frequency amount) and has a high visual quality benefit with a small storage cost as compared to the other derived encoding files. In another example, a derived encoding file (e.g., videoA derived encoding entry 414f) may be ranked at a lower priority than other derived encoding files (e.g., videoA derived encoding entries 414a-e, videoA derived encoding entry 4144g) in storage in one or more data centers if the derived encoding file is watched less often (is less frequently watched, is watched less than a dynamic threshold frequency amount) and has a low visual quality benefit with a high storage cost as compared to the other derived encoding files.

An asset management system may determine a replication factor for a derived encoding file based on a frequency of use of the derived encoding file. For example, if the frequency of use for a derived encoding file is at or below a dynamic threshold level or value, the asset management system may determine that a replication factor for the derived encoding file may be reduced. Reducing a number of duplicates of the derived encoding file may reduce memory usage in the one or more data centers without compromising durability. However, reducing a number of duplicates of the derived encoding file may compromise availability of these derived encodings. In this case, the asset management system 104 may determine that increased demand for a particular derived encoding file may justify the generation of additional duplicates of the particular derived encoding for storage in the one or more data centers. In another example, if the frequency of use for a derived encoding file is above or exceeds a threshold level or value, the asset management system may generate one or more additional replicated files of the derived encoding file for storage in the one or more data centers.

An asset management system may determine that a derived encoding file for an original video file may be removed or deleted from memory in one or more data centers based on the benefit to cost ratio ranking of the derived encoding file in addition to or along with a frequency of use of the derived encoding file. For example, a derived encoding file that is infrequently used and that has a low benefit to cost ratio may be removed or deleted from memory. In some cases, all duplicates of the derived encoding file along with an originally generated derived encoding file may be removed or deleted from memory. For example, referring to FIGS. 1-3, the asset management system 104 may delete the videoA derived encoding 214f and any replicated versions of the videoA derived encoding 214f that may be stored in the replicated derived encodings storage 212 based on the benefit to cost ratio ranking of the videoA derived encoding entry 414f in the ranked asset table 500 in addition to or along with a frequency of use of the videoA derived encoding 214f. For example, users may not be viewing the video file on the display device 118f of the playback computing device 120f often enough to justify a high cost of storing the derived encoding of the video file for viewing on the display device 118f of the playback computing device 120f. For the infrequent cases where a user wants to view the video file on the display device 118f of the playback computing device 120f, the media delivery module 328 may provide the videoA derived encoding 214e to the playback computing device 120f. Though the visual quality of the videoA derived encoding 214e when displayed on the display device 118f may be reduced or less than a visual quality of the videoA derived encoding 214f when displayed on the display device 118f, a user may be satisfied with the visual quality further justifying the removal or deletion of the videoA derived encodings (the videoA derived encoding 214f and any replicated versions of the videoA derived encoding 214f that may be stored in the replicated derived encodings storage 212).

Based on an average of a frequency of use for each derived encoding of an original video file, a replication factor may be determined for an original video file. For example, if the average frequency of use for the derived encodings is at or below a threshold level or value, the asset management system may determine that a replication factor for the original video file may be reduced. Reducing a number of duplicates of the original video file may reduce memory usage in the one or more data centers. In another example, if the average frequency of use for the derived encodings is above or exceeds the threshold level or value, the asset management system may generate one or more additional replicated files of the original video file for storage in the one or more data centers.

A media content provider may implement a capped or fixed data storage budget (e.g., a soft quota) for file storage in one or more data centers to keep data storage costs under control. For example, the media content provider 130 may implement a soft quota for a total amount of memory for use in the one or more data center 102a as the original media storage 206, the replicated original media storage 208, the derived encodings storage 210, and the replicated derived encodings storage 212. In addition, or in the alternative, the media content provider 130 may implement a respective soft quota for an amount of memory for each type of storage in the one or more data center 102a. For example, the media content provider 130 may implement a first soft quota for an amount of memory for the original media storage 206. The media content provider 130 may implement a second soft quota for an amount of memory for the replicated original media storage 208. The media content provider 130 may implement a third soft quota for an amount of memory for the derived encodings storage 210. The media content provider 130 may implement a fourth soft quota for an amount of memory for the replicated derived encodings storage 212. In some implementations, an amount of memory for each of the first soft quota, the second soft quota, the third soft quota, and the fourth soft quota may be the same. In some implementations, an amount of memory for each of the first soft quota, the second soft quota, the third soft quota, and the fourth soft quota may be different. A soft quota for a total amount of memory for use in the one or more data centers may be the sum of the amount of memory for each of the first soft quota, the second soft quota, the third soft quota, and the fourth soft quota.

A media content provider may determine when a soft quota for a total amount of memory for storage of original and replicated original video files, and derived encodings and replicated derived encodings of video files approaches, meets, or exceeds the soft quota. Based on an amount of memory that may need to be freed up such that the soft quota exceeds a total amount of memory used for storage of original and replicated original video files, and for derived encodings and replicated derived encodings of video files, the media content provider 130 may delete one or more files based on one or more of the processes described herein. For example, the asset management system 104 may access the asset table 334 to implement a data storage reduction process (e.g., a clean-up process, a memory use reduction process) that deletes derived encodings of video files beginning with the lowest ranked derived encoding (the derived encoding with the lowest priority) until an amount of memory is freed such that a total amount of memory used by the one or more data center 102a for storage of original and replicated original video files, and derived encodings and replicated derived encodings of video files is less than or below the soft quota. In addition, or in the alternative, the asset management system 104 may, as part of the data storage reduction process, delete one or more replicated derived encodings and/or one or more replicated original media files until an amount of memory is freed such that a total amount of memory used by the one or more data center 102a for storage of original and replicated original video files, and derived encodings and replicated derived encodings of video files is less than or below the soft quota.

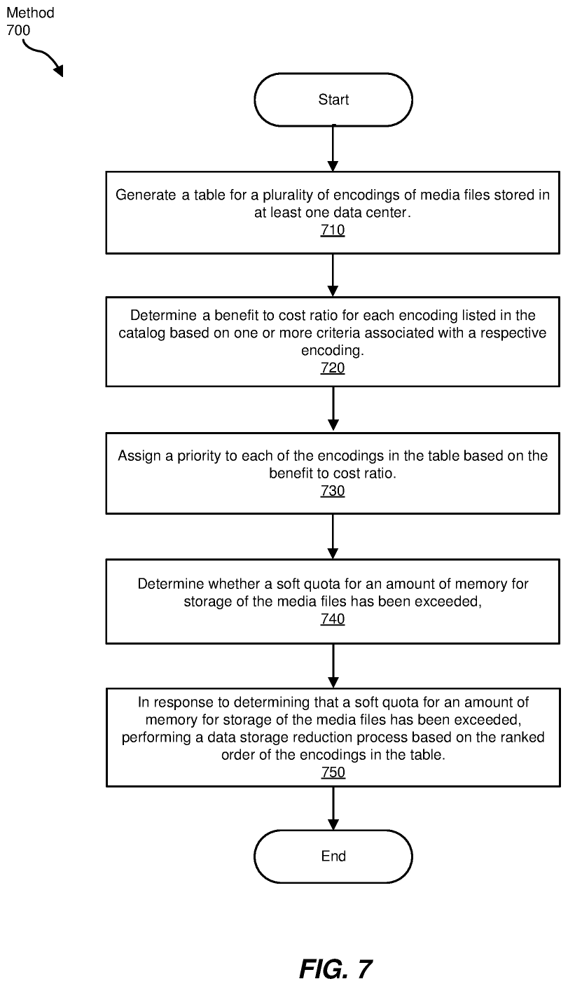

FIG. 7 is a flow diagram of an exemplary computer-implemented method 700 for optimizing a video storage footprint while minimizing user impact. The steps shown in FIG. 7 may be performed by any suitable computer-executable code and/or computing system, including the system(s) illustrated in FIGS. 1-4. In one example, each of the steps shown in FIG. 7 may represent an algorithm whose structure includes and/or is represented by multiple sub-steps, examples of which will be provided in greater detail below.

As illustrated in FIG. 7, at step 710 one or more of the systems described herein may generate a table for a plurality of encodings of media files stored in at least one data center. For example, the asset management system 104 may generate a table for the plurality of encodings of media files stored in the derived encodings storage 210 in the one or more data center 102a.

The systems described herein may perform step 710 in a variety of ways. In one example, the asset management module 326 may generate and/or update the asset table 334 included in the asset catalog 332 on a periodic or regular basis. For example, the asset management module 326 may update the asset table 334 on a time frame basis such as hourly, daily, weekly, or monthly. In addition, or in the alternative, when updating an asset table, an asset management system may update values for the criteria associated with an asset and then may assign an updated priority to an asset entry in the asset table based on the updated values for the criteria. For example, an update to an asset table may result in an asset entry being assign a priority that is different from a prior assigned priority.

As illustrated in FIG. 7, at step 720 one or more of the systems described herein may determine a benefit to cost ratio for each encoding listed in the table based on one or more criteria associated with a respective encoding. For example, the asset management system 104 may determine a benefit to cost ratio for each encoding listed in the asset table 334.

The systems described herein may perform step 720 in a variety of ways. In one example, the asset management module 326 may determine a benefit to cost ratio for each encoding listed in the asset table 334 based on the one or more criteria (e.g., the visual quality benefit determined by the use of Bjontegaard functions (BD rate 402), the delivery frequency 404, the regeneration computing cost 406, and/or the storage cost 408) associated with each entry in the asset table 334.

As illustrated in FIG. 7, at step 730 one or more of the systems described herein may assign a priority to each of the encodings in the table based on the benefit to cost ratio. For example, the asset management system 104 may determine to assign a priority to each encoding listed in the asset table 334.

The systems described herein may perform step 730 in a variety of ways. In one example, the asset management module 326 may assign a priority to each encoding listed in the asset table 334 based on the benefit to cost ratio determined for the respective encoding. The asset management module 326 may assign a first priority to a first derived encoding that is higher or greater than a priority assigned to a second derived encoding if a benefit to cost ratio of the first derived encoding is larger or greater than a benefit to cost ratio of the second derived encoding. For example, a benefit to cost ratio for the videoA derived encoding 214b may be a higher benefit to cost ratio than the benefit to cost ratio for the videoA derived encoding 214g. Therefore, the asset management system 104 may assign or associate a priority to the videoA derived encoding entry 414b in the asset table 334 that is higher than a priority assigned to or associated with the videoA derived encoding 214g.

As illustrated in FIG. 7, at step 740 one or more of the systems described herein may determine whether a soft quota for an amount of memory for storage of the media files has been exceeded. For example, the media content provider 130 may determine if a soft quota for an amount of memory for storage of the media files in the one or more data center 102a has been exceeded.

The systems described herein may perform step 740 in a variety of ways. In one example, the asset management system 104 may monitor memory usage in the one or more data center 102a in comparison to a predetermined soft quota amount of memory to determine when the memory usage is close to, meets, or exceeds the soft quota amount of memory.

As illustrated in FIG. 7, at step 750 one or more of the systems described herein may in response to determining that a soft quota for an amount of memory for storage of the media files has been exceeded, performing a data storage reduction process based on the priority associated with each of the encodings in the table. For example, the asset management module 326 may perform the data storage reduction process based on the priority associated with each derived encoding in the asset table 334.

The systems described herein may perform step 750 in a variety of ways. In one example, the asset management module 326 may perform the data storage reduction process based on the priority associated with each encoding in the asset table 334 by deleting encodings with the lowest priority from the derived encodings storage 210. In addition, or in the alternative, the asset management module 326 in performing the data storage reduction process may also delete one or more replicated derived encodings for a derived encoding from the replicated derived encodings storage 212.

By frequently monitoring the criteria associated with each derived video file on a regular basis along with the monitoring of the memory usage in the one or more data centers, a soft quota for an amount of memory used in the data centers may be maintained without impacting an experience of a user when viewing the video file.

### EXAMPLE EMBODIMENTS

Example 1: A computer-implemented method may include generating a table for a plurality of encodings of media files stored in at least one data center, the generating including determining a benefit to cost ratio for each encoding listed in the table based on one or more criteria associated with a respective encoding, and assigning a priority to each of the encodings in the table based on the benefit to cost ratio, determining whether a soft quota for an amount of memory for storage of the media files has been exceeded, and in response to determining that a soft quota for an amount of memory for storage of the media files has been exceeded, performing a data storage reduction process based on the priority associated with each of the encodings in the table.

Example 2: The computer-implemented method of Example 1, where the one or more criteria may include at least one of a visual quality benefit determined by use of Bjontegaard functions (a RD rate) associated with the encoding, a delivery frequency associated with the encoding, a regeneration computing cost associated with the encoding, or a storage cost associated with the encoding.

Example 3: The computer-implemented method of any of Examples 1 and 2, where assigning a priority to each of the encodings may include assigning a first encoding a higher priority than a second encoding based on a benefit to cost ratio for the first encoding being greater than a benefit to cost ratio for the second encoding.

Example 4: The computer-implemented method of any of Examples 1-3, where performing the data storage reduction process may include deleting a file for a lowest ranked encoding in the table from storage in the at least one data center until an amount of memory for storage of the media files in the at least one data center does not exceed the soft quota.

Example 5: The computer-implemented method of any of Examples 1-4, where the method may further include updating the table on a periodic basis.

Example 6: The computer-implemented method of any of Examples 1-5, where entries in the table may be in a ranked order based on the respective assigned priorities.

Example 7: The computer-implemented method of any of Examples 1-6, where performing the data storage reduction process may further include, based on determining that a frequency of use associated with an original media file is below a threshold value, deleting at least one replication of the original media file from storage in the at least one data center.

Example 8: The computer-implemented method of Example 7, where performing the data storage reduction process may further include, based on determining that the frequency of use associated with the original media file is below the threshold value, reducing a replication factor associated with the original media file.

Example 9: The computer-implemented method of any of Examples 1-8, where performing the data storage reduction process may further include, based on determining that a frequency of use associated with an encoding of an original media file is below a threshold value, deleting at least one replication of the encoding of the original media file from storage in the at least one data center.

Example 10: The computer-implemented method of Example 9, where performing the data storage reduction process may further include, based on determining that the frequency of use associated with the encoding of the original media file is below the threshold value, reducing a replication factor associated with the encoding of the original media file.

Example 11: A system may include at least one physical processor, and physical memory including computer-executable instructions that, when executed by the physical processor, may cause the physical processor to generate a table for a plurality of encodings of media files stored in at least one data center, the generating including determining a benefit to cost ratio for each encoding listed in the table based on one or more criteria associated with a respective encoding, and assigning a priority to each of the encodings in the table based on the benefit to cost ratio, determine whether a soft quota for an amount of memory for storage of the media files has been exceeded, and in response to determining that a soft quota for an amount of memory for storage of the media files has been exceeded, perform a data storage reduction process based on the priority associated with each of the encodings in the table.

Example 12: The system of Example 11, where the one or more criteria may include at least one of a visual quality benefit determined by use of Bjontegaard functions (a RD rate) associated with the encoding, a delivery frequency associated with the encoding, a regeneration computing cost associated with the encoding, or a storage cost associated with the encoding.

Example 13: The system of any of Examples 11 and 12, where assigning a priority to each of the encodings may include assigning a first encoding a higher priority than a second encoding based on a benefit to cost ratio for the first encoding being greater than a benefit to cost ratio for the second encoding.

Example 14: The system of any of Examples 11-13, where performing the data storage reduction process may include deleting a file for a lowest ranked encoding in the table from storage in the at least one data center until an amount of memory for storage of the media files in the at least one data center does not exceed the soft quota.

Example 15: The system of any of Examples 11-14, where the method may further include updating the table on a periodic basis.

Example 16: The system of any of Examples 11 to 15, where entries in the table may be in a ranked order based on the respective assigned priorities.

Example 17: The system of any of Examples 11-16, where performing the data storage reduction process may further include, based on determining that a frequency of use associated with an original media file is below a threshold value, deleting at least one replication of the original media file from storage in the at least one data center.

Example 18: The system of Example 17, where performing the data storage reduction process may further include, based on determining that the frequency of use associated with the original media file is below the threshold value, reducing a replication factor associated with the original media file.

Example 19: The system of any of Examples 11-18, where performing the data storage reduction process may further include, based on determining that a frequency of use associated with an encoding of an original media file is below a threshold value, deleting at least one replication of the encoding of the original media file from storage in the at least one data center.

Example 20: A non-transitory computer-readable medium including one or more computer-executable instructions that, when executed by at least one processor of a computing device of a computing system, may cause the computing device to generate a table for a plurality of encodings of media files stored in at least one data center, the generating including determining a benefit to cost ratio for each encoding listed in the table based on one or more criteria associated with a respective encoding, and assigning a priority to each of the encodings in the table based on the benefit to cost ratio, determine whether a soft quota for an amount of memory for storage of the media files has been exceeded, and in response to determining that a soft quota for an amount of memory for storage of the media files has been exceeded, perform a data storage reduction process based on the priority associated with each of the encodings in the table.

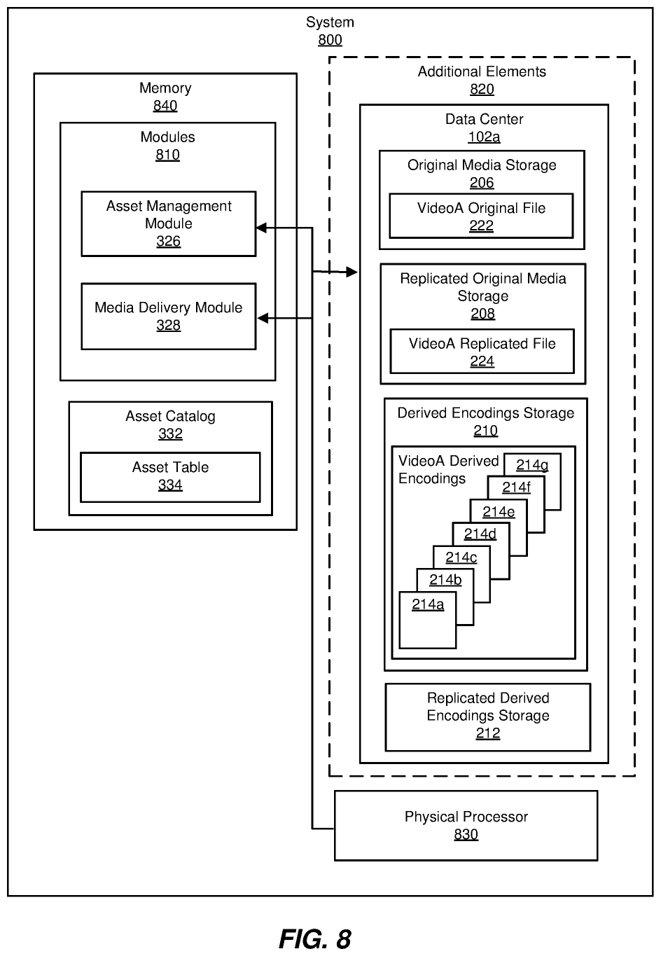

FIG. 8 is a block diagram of an example system 800 that includes modules for use in a system for storing and managing media content. Modules 810 may include the asset management module 326 and the media delivery module 328. Although illustrated as separate elements, one or more of modules 810 in FIG. 8 may represent portions of a single module or application.

In certain embodiments, one or more of modules 810 in FIG. 8 may represent one or more software applications, operating systems, or programs that, when executed by a computing device, may cause the computing device to perform one or more tasks. As illustrated in FIG. 8, example system 800 may also include one or more memory devices, such as memory 840. Memory 840 generally represents any type or form of volatile or non-volatile storage device or medium capable of storing data and/or computer-readable instructions. In one example, memory 840 may store, load, and/or maintain one or more of modules 810. Examples of memory 840 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory. The memory 840 may include the asset catalog 332.

As illustrated in FIG. 8, the example system 800 may also include one or more physical processors, such as physical processor 830. Physical processor 830 generally represents any type or form of hardware-implemented processing unit capable of interpreting and/or executing computer-readable instructions. In one example, physical processor 830 may access and/or modify one or more of modules 810 stored in memory 840. Additionally, or alternatively, physical processor 830 may execute one or more of modules 810. Examples of physical processor 830 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 8, the example system 800 may also include one or more additional elements 820. The additional elements 820 generally represent any type or form of hardware and/or software. In one example, physical processor 830 may access and/or modify one or more of the additional elements 820.

One or more repositories may include the additional elements 820. The one or more repositories may be memory (e.g., the memory 840). The one or more repositories may be databases. In some implementations, the additional elements 820 may be included (part of) the system 800. In some implementations, the additional elements 820 may be external to the system 800 and accessible by the system 800. The additional elements 820 may include the one or more data center 102a.

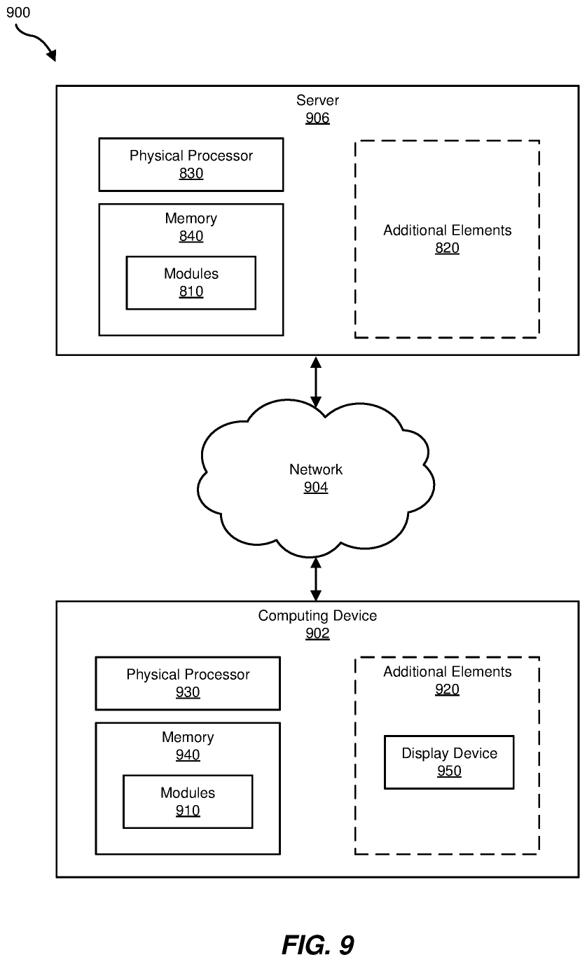

FIG. 9 illustrates an exemplary network environment 900 in which aspects of the present disclosure may be implemented. The network environment 900 may include one or more computing devices (e.g., computing device 902 and server 906) and the network 904. For example, referring to FIG. 1, the server 906 may represent the media content provider 130. For example, referring to FIG. 1, the computing device 902 may represent the playback computing devices 118a-g.

In this example, the server 906 may include the physical processor 830 that may be one or more general-purpose processors that execute software instructions. The server 906 may include a data storage subsystem that includes the memory 840 which may store software instructions, along with data (e.g., input and/or output data) processed by execution of those instructions. The memory 840 may include modules 810 that may be used to control the operation of the server 906. The server 906 may include additional elements 820. In some implementations, all or part of the additional elements 820 may be external to the server 906 and the computing device 902 and may be accessible by the server 906 either directly (a direct connection) or by way of the network 904.

The computing device 902 may represent a client device, a user device, or a playback computing device such as desktop computer, laptop computer, tablet device, smartphone, a smart television, or other computing device capable of receiving and displaying streaming media content.

The computing device 902 may include a physical processor 930, which may represent a single processor or multiple processors, and one or more memory devices (e.g., memory 940), which may store instructions (e.g., software applications) and/or data in one or more modules 910. The modules 910 may store software instructions, along with data (e.g., input and/or output data) processed by execution of those instructions. The computing device 902 may include additional elements 920. The additional elements 920 may include a display device 950 for the computing device 902. For example, referring to FIG. 1, the computing device 902 may represent one of the playback computing devices 118a-g and the display device 950 may represent the respective display devices 120a-g.

The computing device 902 may be communicatively coupled to the input server 906 through the network 904. The network 904 may be any communication network, such as the Internet, a Wide Area Network (WAN), or a Local Area Network (LAN), and may include various types of communication protocols and physical connections. The server 906 may communicatively connect to and/or interface with various devices through the network 904. In some embodiments, the network 904 may support communication protocols such as transmission control protocol/Internet protocol (TCP/IP), Internet packet exchange (IPX), systems network architecture (SNA), and/or any other suitable network protocols. In some embodiments, data may be transmitted by the network 904 using a mobile network (such as a mobile telephone network, cellular network, satellite network, or other mobile network), a public switched telephone network (PSTN), wired communication protocols (e.g., Universal Serial Bus (USB), Controller Area Network (CAN)), and/or wireless communication protocols (e.g., wireless LAN (WLAN) technologies implementing the IEEE 802.11 family of standards, Bluetooth, Bluetooth Low Energy, Near Field Communication (NFC), Z-Wave, and ZigBee).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive values for one or more criteria associated with an asset to be transformed, transform the one or more criteria to determine a priority for the asset, output a result of the transformation to an asset management module for storage in an asset table, and use the result of the transformation to perform a data storage reduction process. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
generating a table for a plurality of encodings of media files stored in at least one data center, the generating comprising:
determining a benefit to cost ratio for each encoding listed in the table based on one or more criteria associated with a respective encoding; and
assigning a priority to each of the encodings in the table based on the benefit to cost ratio;
determining whether a soft quota for an amount of memory for storage of the media files has been exceeded; and
in response to determining that a soft quota for an amount of memory for storage of the media files has been exceeded, performing a data storage reduction process based on the priority associated with each of the encodings in the table.

2. The method of claim 1, wherein the one or more criteria comprise at least one of a visual quality benefit determined by use of Bjontegaard functions (a RD rate) associated with the encoding, a delivery frequency associated with the encoding, a regeneration computing cost associated with the encoding, or a storage cost associated with the encoding.

3. The method of claim 1, wherein assigning a priority to each of the encodings comprises assigning a first encoding a higher priority than a second encoding based on a benefit to cost ratio for the first encoding being greater than a benefit to cost ratio for the second encoding.

4. The method of claim 1, wherein performing the data storage reduction process comprises deleting a file for a lowest ranked encoding in the table from storage in the at least one data center until an amount of memory for storage of the media files in the at least one data center does not exceed the soft quota.

5. The method of claim 1, further comprising updating the table on a periodic basis.

6. The method of claim 1, wherein entries in the table are in a ranked order based on the respective assigned priorities.

7. The method of claim 1, wherein performing the data storage reduction process further comprises, based on determining that a frequency of use associated with an original media file is below a threshold value, deleting at least one replication of the original media file from storage in the at least one data center.

8. The method of claim 7, wherein performing the data storage reduction process further comprises, based on determining that the frequency of use associated with the original media file is below the threshold value, reducing a replication factor associated with the original media file.

9. The method of claim 1, wherein performing the data storage reduction process further comprises, based on determining that a frequency of use associated with an encoding of an original media file is below a threshold value, deleting at least one replication of the encoding of the original media file from storage in the at least one data center.

10. The method of claim 9, wherein performing the data storage reduction process further comprises, based on determining that the frequency of use associated with the encoding of the original media file is below the threshold value, reducing a replication factor associated with the encoding of the original media file.

11. A system comprising:
at least one physical processor; and
physical memory comprising computer-executable instructions that, when executed by the physical processor, cause the physical processor to:
generate a table for a plurality of encodings of media files stored in at least one data center, the generating comprising:
determining a benefit to cost ratio for each encoding listed in the table based on one or more criteria associated with a respective encoding; and
assigning a priority to each of the encodings in the table based on the benefit to cost ratio;
determine whether a soft quota for an amount of memory for storage of the media files has been exceeded; and
in response to determining that a soft quota for an amount of memory for storage of the media files has been exceeded, perform a data storage reduction process based on the priority associated with each of the encodings in the table.

12. The system of claim 11, wherein the one or more criteria comprise at least one of a visual quality benefit determined by use of Bjontegaard functions (a RD rate) associated with the encoding, a delivery frequency associated with the encoding, a regeneration computing cost associated with the encoding, or a storage cost associated with the encoding.

13. The system of claim 11, wherein assigning a priority to each of the encodings comprises assigning a first encoding a higher priority than a second encoding based on a benefit to cost ratio for the first encoding being greater than a benefit to cost ratio for the second encoding.

14. The system of claim 11, wherein performing the data storage reduction process comprises deleting a file for a lowest ranked encoding in the table from storage in the at least one data center until an amount of memory for storage of the media files in the at least one data center does not exceed the soft quota.

15. The system of claim 11, further comprising updating the table on a periodic basis.

16. The system of claim 11, wherein entries in the table are in a ranked order based on the respective assigned priorities.

17. The system of claim 11, wherein performing the data storage reduction process further comprises, based on determining that a frequency of use associated with an original media file is below a threshold value, deleting at least one replication of the original media file from storage in the at least one data center.

18. The system of claim 17, wherein performing the data storage reduction process further comprises, based on determining that the frequency of use associated with the original media file is below the threshold value, reducing a replication factor associated with the original media file.

19. The system of claim 11, wherein performing the data storage reduction process further comprises, based on determining that a frequency of use associated with an encoding of an original media file is below a threshold value, deleting at least one replication of the encoding of the original media file from storage in the at least one data center.

20. A non-transitory computer-readable medium comprising one or more computer-executable instructions that, when executed by at least one processor of a computing device, cause the computing device to:
generate a table for a plurality of encodings of media files stored in at least one data center, the generating comprising:
determining a benefit to cost ratio for each encoding listed in the table based on one or more criteria associated with a respective encoding; and
assigning a priority to each of the encodings in the table based on the benefit to cost ratio;
determine whether a soft quota for an amount of memory for storage of the media files has been exceeded; and
in response to determining that a soft quota for an amount of memory for storage of the media files has been exceeded, perform a data storage reduction process based on the priority associated with each of the encodings in the table.
